(19) United States
(12) Patent Application Publication
(10) Pub. No.: US 2003/0163542 A1
(43) Pub. Date: Aug. 28, 2003

(54) Remote control signals updated and stored via network

(75) Inventors: Willem Bulthuis, Portola Valley, CA (US); Yevgenity Eugene Shteyn, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/087,475

(22) Filed: Feb. 28, 2002

(51) Int. Cl. G06F 15/16

(52) U.S. Cl. 709/208; 709/220

(57) ABSTRACT

A universal programmable remote control detects the presence of a control code of a new apparatus in the user's CE environment. The code or representatives thereof gets communicated to a network-based server. The server maintains a database of codes and distributes the new set of codes to the remote and to other control devices as needed.

### FIELD OF THE INVENTION

The invention relates to remote control devices and to a service for enabling the programming of remote controls to be used with consumer electronics (CE) equipment.

Universal programmable remote control devices, e.g., the PRONTO (TM) made by Philips Electronics, are well known. The expression “universal remote” indicates a device that enables the end-user to control the majority of his/her collection of remotely controllable apparatus, regardless of the type or brand of the individual apparatus. This universal controllability is achieved by accommodating, e.g., on the remote a database of multiple sets of existing control (IR or RF) codes, each particular set being associated with a particular type of apparatus of a particular brand. The universal remote is user-programmable and capable of learning or adopting new control codes and of associating them with a particular user-defined soft key or hard button. The PRONTO (TM), for example, has built-in RC-5 and RC-6 codes for Philips and Marantz equipment, IR-sending and IR-receiving eyes, and an RS232 serial port connector for after-market expansibility of the codes, e.g., via a PC, and a touch screen functionality.

U.S. Pat. No. 5,819,294 (attorney docket PHA 23,261), issued to Paul Chambers and incorporated herein by reference, discloses a programmable remote controller which is programmed using a data base for sets of codes used by a variety of commercially available remote controllers. In order to program the remote, a match is to be found between a pulse-code transmitted by a specific known controller on the one hand and an item in the database on the other hand. Upon finding the match, the set containing the matching item is stored in the programmable controller as corresponding to the particular apparatus that is controllable via the specific remote.

U.S. Ser. No. 09/653,784 (attorney docket US 000220) filed Sep. 1, 2000 for Frank Caris et al., for STB CONNECTS REMOTE TO WEB SITE FOR CUSTOMIZED CODE DOWNLOADS, incorporated by reference, relates to the following. A set top box (STB) is marketed together with a programmable remote. The remote has a dedicated button to connect the STB to a specific server on the Internet. The consumer can notify the server of his/her other CE equipment, which he/she desires to be controllable through the same remote as the one that came with the STB. The server downloads to the STB data representative of the relevant control codes. The STB is provided with means to program the remote with these codes. In return the server has obtained detailed and accurate information about this consumer's equipment. A reliable customer base can thus be built for streamlining Help Desk operations.

### SUMMARY OF THE INVENTION

New generations of CE equipment may introduce new functionalities for which new control codes have been engineered. Accordingly, up-to-date control information, e.g., IR or RF control codes, for use by remote controls and other programmable or software-upgradeable control apparatus in the field is a valuable asset. An appealing feature of a universal remote control is its ability to control a wide variety of apparatuses in one's environment. Rapidly developing CE industry presents a relentless challenge to manufacturers and users of universal remotes, as new equipment with ever expanding functionality comes to the market. Proliferation of home networking solutions increases the difficulty of providing universal control functionality: new and legacy IR signals are being used in combination with RF; networked controllers, e.g., UPnP-compliant user control points, operate on a different network level then traditional wireless remotes, etc.

It is an object of the invention to provide a self-sustaining forward-compatible infrastructure for updating control signal information for universal remote controls. It is a further object of the invention to enable the infrastructure to provide services to OEM manufacturers. It is another object of the invention to enhance user control and interaction experience.

These and other objects of the invention are achieved by having a programmable remote control device detecting, e.g., a new control signal, storing the signal in the device's memory, so as to communicate the signal characteristics to the device's support service, e.g., on the Internet. More in general, the invention, as seen from the user's side, relates to a method of enabling to program a control device, e.g., a programmable remote control device, for remote control of an apparatus. The method comprises enabling the control device to detect an identity of the apparatus, e.g., based on capturing a representative control command for control of the apparatus, determining characteristics of a control signal, determining a MAC address of the apparatus, bar code ID of the apparatus, or type and serial number of the apparatus, etc. The method further comprises enabling to communicate first data that is representative of the identity via a data network, e.g., the Internet, to a service. The service then determines, directly or indirectly, a set of control commands for control of the apparatus, based on the identity communicated. Then, second data is received, e.g., by the control device, from the service or another source, for programming the control device with the set of control commands for the apparatus.

The invention, as seen from the service side, relates to a method of enabling to program the control device for control of the apparatus. The method comprises receiving from a control device and via a data network first data representative of the identity of the apparatus. A set of control commands is then determined, based on the first data received. Then, second data is communicated representative of the set for being programmed in the control device. The method of the invention may also comprise contacting a third party, e.g., the manufacturer of the apparatus, for acquiring the set associated with the identity of the apparatus if the set is not present in the server's database. The method of the invention may further comprise communicating the set to at least one other control device. For example, users or retailers can register with the service to automatically receive the code sets for all or for specific apparatus when the server gets contacted for the first time with a request from a remote control device to transmit a new code set.

The invention further relates to a programmable remote control device comprising circuitry for determining an identify of a specific controllable apparatus, e.g., circuitry for capturing a control signal for remote control of the apparatus and for determining data representative of a characteristic of the signal. The remote also has circuitry for communicating the identity, or data representative thereof, to a source external to the device, e.g., a server on the Internet. The programmable remote thus communicates information to be used elsewhere to run a query on a database of remote control commands, for thereafter receiving the data representative of a complete command set for the apparatus and to be programmed in the remote.

The characteristics of the control signal may be extracted by the programmable remote control device. In one example, signal characteristics include IR carrier frequency and bit pattern. In another example, the signal is a SOAP (Simple Object Access Protocol) communication message transmitted using an 802.11b wireless communication protocol. SOAP is a lightweight protocol for exchange of information in a decentralized, distributed system. SOAP is an XML-based protocol that consists of three parts: an envelope that defines a framework for describing what is in a message and how to process it, a set of encoding rules for expressing instances of application-defined data types, and a convention for representing remote procedure calls and responses. (see, http://www.w3.org/TR/SOAP/for more information). In this case the remote control device may perform operations in order to extract the contents of the message, its destination, the address-controlled apparatus and retrieve its description.

In yet another embodiment, a network-attached receiver, e.g., a network access point, detects a new unfamiliar UPnP command transmitted over the wireless home network. The command is parsed by the system and new control and device identification information is extracted. A new set of control codes is derived from the device identification, e.g., a standard functionality type such as a PVR (Personal Video Recorder, or HDD based digital video recorder), a DVD player, etc. The new set of codes is then mapped onto an existing set of buttons or UIs for remote controls.

Alternatively, the remote control device detects an identification signal from the controlled apparatus. The identification signal may also be provided by the apparatus itself on request from, e.g., the remote control.

The support service is configured to receive the signal, and then determine if it belongs to a known set of signals associated with a controllable apparatus. The service is further enabled to identify the original manufacturer of the controllable apparatus, e.g., using the IR control signal pattern, the apparatus' identification information, etc. The service is further enabled to request a control signal set, preferably with a user interface mapping, from the manufacturer or another third party. The information mentioned above can be advantageously used by, e.g., manufacturers to determine product buying patterns, consumer preferences, user scenarios, etc.

The process results in updating at least on of the following: a database of control signal information at the service site or on the remote control device, other remote controls in the field of operational use or in the manufacturing stage. The update requires minimal or no user intervention.

The invention may also be implemented in retail floor or exhibition environments, so as to facilitate equipment demonstration by, e.g., sales associates, and promote sales of universal remote controls.

Additional advantages and novel features will be set forth in the description which follows, and in part may become apparent to those skilled in the art upon examination of the following, or may be learned by practice of the invention.

### BRIEF DESCRIPTION OF THE DRAWING

The invention is explained in further details, by way of examples, and with reference to the accompanying drawing wherein:

FIG. 1 is a block diagram of a user environment suitable for use of an embodiment of the present invention;

FIG. 2 is a block diagram of an embodiment of the invention; and

FIG. 3 is a flow diagram illustrating a method of control signal analysis and update of the invention.

### DETAILED DESCRIPTION OF THE INVENTION

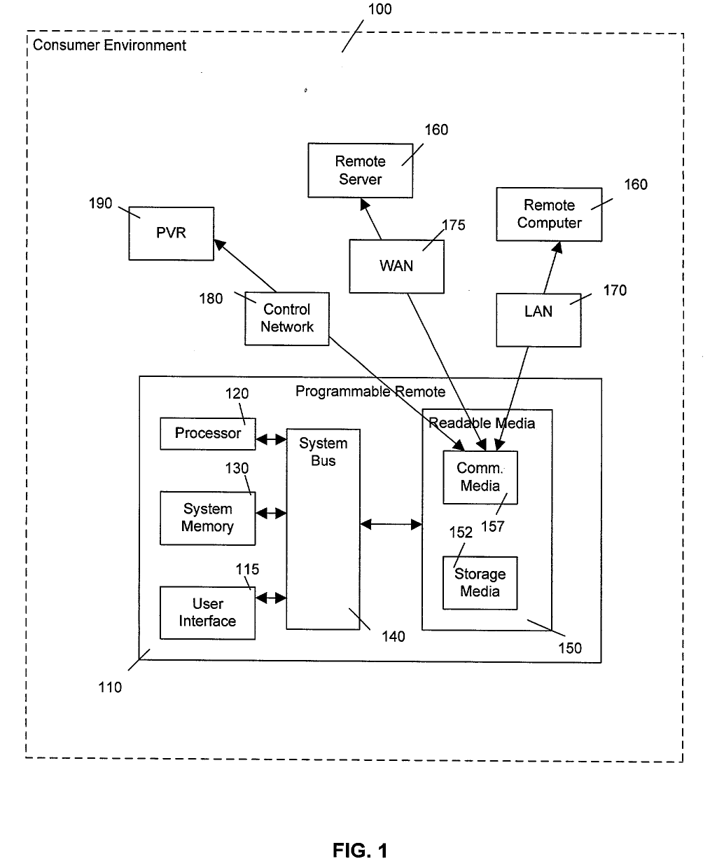

The present invention provides a method and system for updating control signal information for universal remote controls. FIG. 1 is a block diagram of a consumer environment 100 suitable for use in implementing the present invention. The user environment 100 is only one example of a suitable control environment and is not intended to suggest any limitation as to the scope of use or functionality of the invention. Neither should the user environment 100 be interpreted as having any dependency or requirement relating to any one or combination of components illustrated in the exemplary operating environment 100.

The invention is operational with numerous other general purpose or special purpose user environments or configurations. Examples of well known user environments, and/or configurations that may be suitable for use with the invention include, but are not limited to, audio and video, home automation, home security, home office, small office, and the like.

With reference to FIG. 1, an exemplary system for implementing the invention includes a learning remote control device in the form of an advanced universal remote 110. Components of remote 110 include, but are not limited to, a data processing unit 120, a system memory 130, and a system bus 140 that couples various system components including system memory 130 to processing unit 120. Advanced remote control device 110 includes readable media 150. Readable media 150 can include one or more media that can be accessed by remote 110. Readable media 150 may include volatile and/or nonvolatile media, removable and/or non-removable media. Readable media 150 in this example comprise storage media 152 and communication media 157. Storage media 152 include volatile and nonvolatile, removable and non-removable media implemented in any method or technology for storage of information such as computer readable instructions, data structures, program modules or other data. Storage media 152 includes, but is not limited to, RAM, ROM, EEPROM, flash memory or other memory technology. Communication media 150 typically embody computer readable instructions, data structures, program modules or other data representative of a modulated data signal such as a carrier wave or other transport mechanism and include any information delivery media. Communication media 150 include wireless media such as acoustic, RF, infrared and other wireless media.

Advanced remote control device 110 operates in a networked environment using logical connections to one or more remote computers, such as a remote computer 160. Remote computer 160 may be a server, a peer node on a distributed network, a networked PC, etc. The logical connections depicted in FIG. 1 include a local area network (LAN) 170, a wide area network (WAN) 175, etc. Remote 110 also operates in a logical control network 180, which includes devices 190. Devices 190 may include a TV, a PVR or hard-disk based video recorder, a home entertainment server, a PC, an audio player, a thermostat, a light controller, a network gateway device, a remote control, etc. Combinations of aforementioned networking environments are typically present in the home, small office, home office and other user settings.

Advanced remote control device 110 includes user interface means 115. User interface means 115 may include one or more of a keyboard, a microphone and/or speakers, a display, a touch pad, etc. Means 115 enables remote 110 to receive user input and present to the user content, control options, communications options, applications and other options available from system memory 130 and storage media 150 using aforementioned network environments 170, 175, and 180.

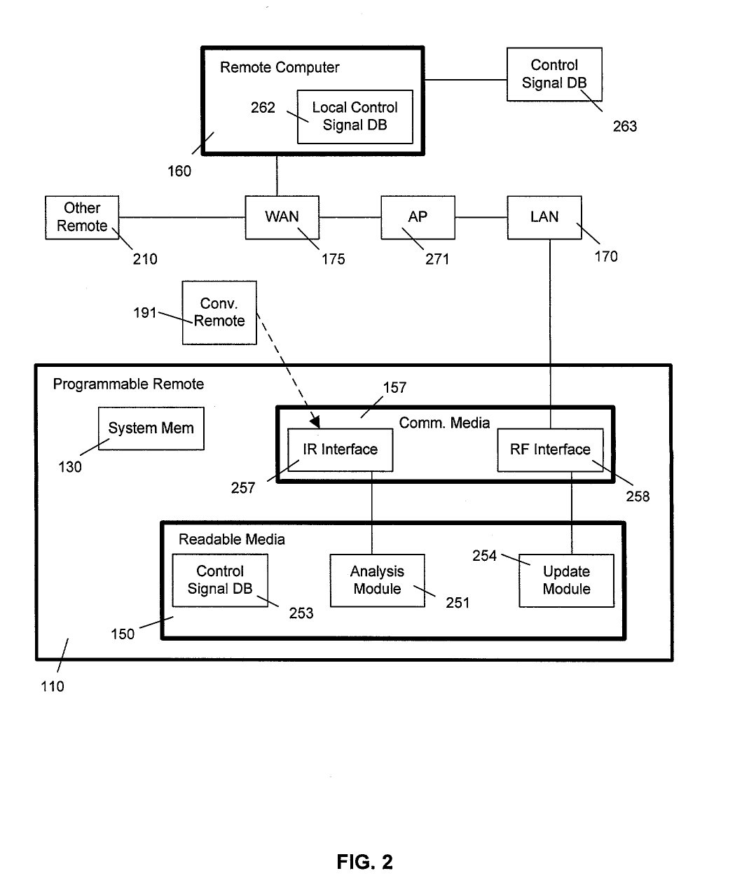

FIG. 2 is a block diagram of a first embodiment of the invention. When the user purchases new CE equipment (not shown), a conventional (non-universal, non-programmable) remote control 191 is packaged with this equipment. The user inputs a specific IR control signal of conventional remote 191 via communication media 157 into remote 110. An IR interface 257 receives the signal, extracts physical characteristics, such as carrier frequency, bit pattern, time delays, etc. A signal analysis module 251 processes the characteristics in order to identify the signal using control signal database 253. Module 251 may be implemented in hardware, software or a combination of both. The hardware portion may include built-in read-only instructions to process standard IR signals, e.g., Philips RC6. The software may translate the bit pattern into device type and ID. Control signal database 253 contains identifiable sets for IR codes mapped, for example, to the manufacturer of the new CE equipment. Alternatively, or in addition, an update module 254 is enabled to communicate to remote computer 160 using an RF network interface 258, e.g., via an 802.11b compliant access point 271. Remote computer 160 implements a search process to locate a set of control codes associated with the entertainment center. The process results in obtaining the set from a local database 262 or a remote database 263. Computer 160 communicates with update module 254 in order to update control signal database 253. Computer 160 may also communicate with another remote control device 210 to update the database of the latter (not shown) as well. Remote database 263 may reside on a computer of the manufacturer of the controlled device, or of the original equipment manufacturer (OEM), or the manufacturer of the remote control, or the product support site, etc. The database may also be distributed amongst the aforementioned WAN computers.

In a software implementation of the invention, modules 253, 251 and 254 may be stored in media 150 and loaded into system memory 130 at the run time.

A person skilled in the art would recognize that communications, processing and update in the present invention could be done in real time or with time delays, based on network options, readable media configuration, user preferences and other factors

In another example, the new CE equipment has an ID that advanced remote 110 forwards to remote computer 160. An ID may be a serial number, IPv6 address, MAC address, etc., and is entered, e.g., manually into remote 110 by the user or gets scanned in, e.g., as a bar-code, etc. Remote computer 160 notifies interested parties (or a log) of the appearance of a new product in the field, and updates database 262 and/or database 263 if needed.

In another example, a learning network control device (not necessarily a remote control), e.g., an RF dongle of a set-top box or a network media player, picks up a control signal from a user control point. The signal is formatted as a SOAP message. An XML parser parses the message, extracts the device ID and communicates it to server 160. A new UI and control codes (SOAP messages, possibly with IR and/or RF component) are loaded onto the network controller.

Within the context of XML, see, e.g., U.S. Ser. No. 09/686,572 (attorney docket US 000183) filed Oct. 10, 2000 for Eugene Shteyn et al., for CONTROL CODES FOR PROGRAMMABLE REMOTE SUPPLIED IN XML FORMAT, herein incorporated by reference. This patent document addresses the following. The universal programmability of remote controls and other programmable or software-upgradeable CE apparatus is a valuable asset. It is an incentive for third parties to offer value-added features to the equipment's expandible functionality. In order to facilitate this, a mark-up language format can be used, preferably an XML (Extensible Markup Language) data format, in a service for supplying IR or RF commands for being installed on a remote control. The data can be supplied via a data network such as the Internet, or on a carrier such as a memory card. This data represents a control code, and preferably a GUI, to be installed on the remote that, when activated, determines the relevant IR or RF command. The data can be stored locally at the remote. An XML application, such as an XSL stylesheet, at the receiving end, operates on the data under control of instructions in the stylesheet. This application is used, for example, for control of generating the proper IR or RF commands based on the received data and for generating a GUI as an, e.g., HTML page on a suitable display. If necessary, the data is converted to a proprietary format local to the remote before getting installed. An advantage of the above resides in the fact that an open standard, such as XML/XSL for defining the behavior and appearance of a remote's GUI, allows development of supporting tools by third parties. Preferably, the data is provided via a data network, e.g., the Internet. The user is enabled to specify to a server on the network an apparatus for being controlled by the control device. The server then identifies a corresponding control code for being provided as the data in the mark-up language format. The method can comprise providing a GUI element for use on the control device, the GUI element being supplied as further data in the mark-up language format. The GUI element can comprise a graphical representation of another remote control device. This latter feature is especially interesting if the universal programmable remote is to become the user's main remote for his/her CE equipment. It is assumed that the universal remote has a touch screen GUI. All relevant control codes of the separate remotes for individual pieces of equipment are now programmed in the universal remote using the scenario briefly discussed above and in more detail below. Assume that the universal remote, such as the PRONTO (TM) can reserve one or more graphical control panels per piece of equipment. That is, the control functionalities per piece of equipment are clustered. The graphical representation of these panels is shaped as an image of the remote dedicated to that piece of equipment. That is, the universal remote displays an image of the dedicated remote with the control functionalities represented as soft keys where the dedicated remote provides hard keys. This enables quick recognition by the user and also allows the user to effortlessly switch between manipulating the universal remote and the dedicated remote. This feature can also be provided independent of the XML approach discussed above. Accordingly, a server provides data to an end-user, preferably in XML format, for programming, setting up and control of local CE equipment. Using XML, the content/service provider does not need to support all possible target devices. Accordingly, the data can be supplied and put together without having to consider the particularities of the destination platform on which the data is to be installed. An XML application (here: a parser) extracts the relevant items and attributes from the XML data received and transforms them to further data that can be installed and/or processed locally at the destination platform.

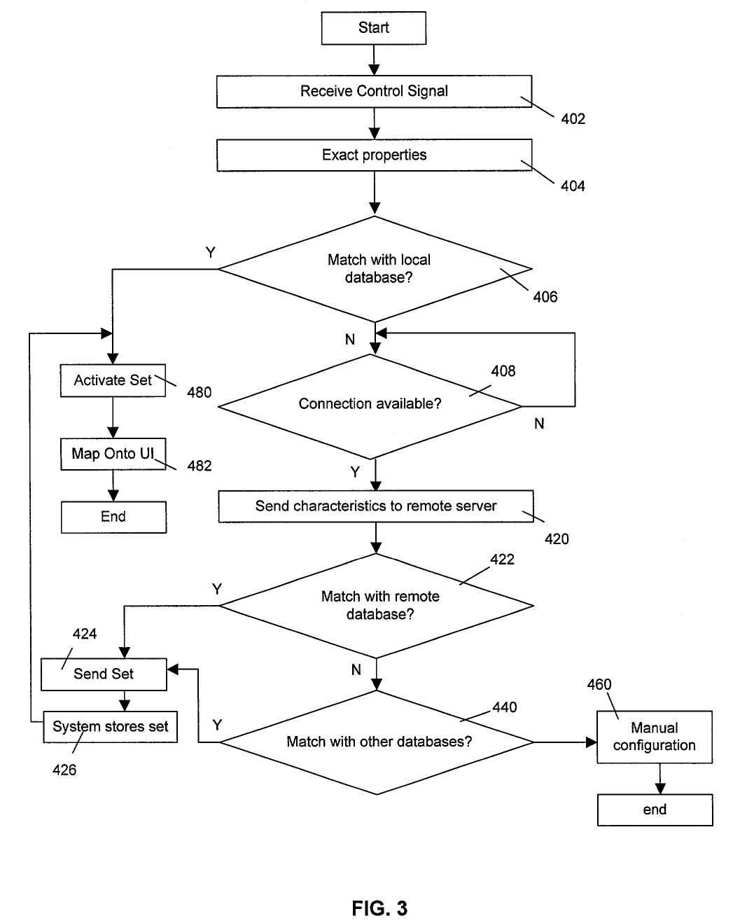

FIG. 3 is a flow diagram illustrating a method of control signal analysis and update in the invention. In step 402 a control signal is received and the signal properties are extracted in step 404. The properties are, for example, signal carrier frequency, the length of individual pulses, time intervals between pulses and others. In step 406 the characteristics are compared to the ones in a locally available database or a look-up table. If a match is found, the system in step 480 activates a command set associated with the signal and maps it in step 482 onto a user interface, such as buttons, GUI or voice commands. If in step 406 a match is not found, the system checks in step 408 whether a connection to remote computer 160 is available or not. If not, the system enters a waiting routine, which, e.g., periodically or upon a command, repeats step 408. If a connection is available, the signal characteristics are sent to remote computer 160 in a step 420. The characteristics are tested against existing information in step 422. The testing can be performed by direct matching of the signal characteristics with the ones available to the remote computer. Alternatively, secondary characteristics, such as manufacturer ID, device type, signal bit pattern and others can be derived from the original signal and used for matching. If a match is found, a set of commands and UI mapping is created and sent to the system in step 424. In step 426 the system stores the information and transitions to step 480. An additional step (not shown) may be that a process is initiated of updating other receivers, e.g., registered for the update or at a manufacturing site. If a match is not found in step 422, the remote computer accesses in step 440 other databases, e.g., available through OEM extranet remote computer(s) or user preferences databases on the equipment distributor/reseller site, etc. If a match is found, the system transitions to step 424. Otherwise, a manual configuration process is initiated in step 460. An implementation of a manual universal remote control configuration is well understood in the art, e.g., see the Philips Electronics user manual for the PRONTO. For example, the user may be asked for the type and/or manufacturer of the controlled device, offered a UI for the type and asked to enter control codes and associate them with UI elements. All the information entered by the user, including, for example, IR codes and their respective functional mapping, can be sent to the remote computer. The remote computer may match the user's set against the ones already present in the database. If a match is not found, the remote computer may store the set for future references. In the latter example, a collaborative environment for a community of users is created in order to maintain an up-to-date control signal database. Such database can be also used for verification of user input, completion of a control set, and other purposes.

What is claimed is:

1. A method of enabling to program a control device for control of an apparatus, the method comprising:
enabling the control device to detect a representation of an identity of the apparatus;
enabling to communicate first data representative of the representation to a service via a data network; and
receiving second data for programming the control device with control commands for the apparatus.

2. The method of claim 1, wherein the first data is representative of a control signal for control of the apparatus.

3. A method of enabling to program a control device for control of an apparatus, the method comprising:
receiving from the control device via a data network first data representative of a control signal for control of the apparatus;
determining a set of control commands matching the first data; and
communicating second data representative of the set for being programmed in the control device.

4. The method of claim 3, wherein the determining comprises contacting a third party for acquiring the set.

5. The method of claim 4, further comprising communicating the set to at least one other control device.

6. A programmable remote control device comprising circuitry for determining data representative of an identity of a controllable apparatus and for communicating the data to a source external to the device.

7. The device of claim 6, wherein the circuitry comprises a capturing circuit for capturing a control signal for control of the controllable apparatus for determining the data.
